(19) United States
(12) Patent Application Publication
(10) Pub. No.: US 2026/0121192 A1
(43) Pub. Date: Apr. 30, 2026

(54) ENERGY STORAGE APPARATUS

(71) Applicant: GS Yuasa International Ltd., Kyoto-shi (JP)

(72) Inventor: Koki MAEDA, Kyoto-shi (JP)

(21) Appl. No.: 19/425,332

(22) Filed: Dec. 18, 2025

Related U.S. Application Data
(63) Continuation of application No. PCT/JP2024/022238, filed on Jun. 19, 2024.

(30) Foreign Application Priority Data
Jun. 22, 2023 (JP) 2023-102298

(51) Int. Cl. H01M 50/242; H01M 50/209

(52) U.S. Cl. CPC H01M 50/242; H01M 50/209

(57) ABSTRACT

An energy storage apparatus includes an energy storage device, an end plate arranged in a first direction of the energy storage device, and a side plate extending in the first direction and joined to the end plate, in which in at least one of the end plate or the side plate, a protruding portion is provided in at least one corner portion at which the first direction and a second direction which is orthogonal to the first direction intersect each other, and the protruding portion is configured such that a space, which opens on a side of the energy storage device, is defined by a deformation portion of at least one of the end plate or the side plate projected toward an outer side.

### CROSS REFERENCE TO RELATED APPLICATIONS

This application claims the benefit of priority to Japanese Patent Application No. 2023-102298 filed on Jun. 22, 2023 and is a Continuation Application of PCT Application No. PCT/JP2024/022238 filed on Jun. 19, 2024. The entire contents of each application are hereby incorporated herein by reference.

### BACKGROUND OF THE INVENTION

### 1. Field of the Invention

The present invention relates to energy storage apparatuses.

### 2. Description of the Related Art

Japanese Unexamined Patent Application Publication No. 2020-57520 discloses a battery module including a plurality of battery cells, a pair of end plates, and a pair of restraining members. The plurality of battery cells are aligned in one direction, and a pair of end plates are disposed at both ends of the battery cells. In addition, the pair of restraining members are disposed so as to sandwich the plurality of battery cells and the pair of end plates in a direction orthogonal to the direction in which the plurality of battery cells are aligned. Further, both ends of the pair of restraining members are joined to the pair of end plates. Thus, the plurality of battery cells are fixed by using the pair of end plates and the pair of restraining members.

### SUMMARY OF THE INVENTION

In the above-described conventional battery module, since the battery cells swell due to charge and discharge, a force acts on the end plates or the restraining members due to the swelling. In order to reduce or prevent damage to the end plates or the restraining members caused by this force, one possible action is to enhance rigidity of the end plates or the restraining members. However, if the rigidity is simply enhanced, a cost of the end plates or the restraining members may increase, or the mass of the battery module may increase. In view of the above, it is necessary to absorb the force which acts on the end plates or the restraining members.

Example embodiments of the present invention provide energy storage apparatuses each capable of absorbing a force which acts on an end plate or a side plate when an energy storage device swells.

An energy storage apparatus according to an example embodiment of the present invention includes an energy storage device, an end plate arranged in a first direction of the energy storage device, and a side plate extending in the first direction and joined to the end plate, wherein in at least one of the end plate or the side plate, a protruding portion is provided in at least one corner portion at which the first direction and a second direction which is orthogonal to the first direction intersect each other, and the protruding portion is configured such that a space, which opens on a side of the energy storage device, is defined by a deformation portion of at least one of the end plate or the side plate projected toward an outer side.

According to energy storage apparatuses of example embodiments of the present invention, it is possible to absorb the force which acts on the end plate or the side plate when the energy storage device swells.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a configuration of an energy storage apparatus (in a state in which an exterior body is removed) according to an example embodiment of the present invention.

FIG. 2 is a plan view illustrating a configuration of an energy storage apparatus (in a state in which the exterior body is removed) according to an example embodiment of the present invention.

FIG. 3 is a perspective view illustrating a configuration of an end plate according to an example embodiment of the present invention.

FIG. 4 is a perspective view illustrating a configuration of a side plate according to an example embodiment of the present invention.

FIG. 5 is a perspective view illustrating a configuration of the energy storage apparatus (in a state in which the exterior body is mounted) according to an example embodiment of the present invention.

FIG. 6 is a cross-sectional view illustrating a configuration of an energy storage apparatus (in a state in which the exterior body is mounted) according to an example embodiment of the present invention.

FIG. 7 is a cross-sectional view indicating a behavior of an end plate when an energy storage apparatus according to an example embodiment of the present invention has swollen.

FIGS. 8A and 8B are schematic views showing simulation results of stress distributions when a force is applied to an end plate of a comparative example and an end plate according to an example embodiment of the present invention.

FIG. 9 is a cross-sectional view illustrating a configuration of an end plate and a side plate according to Modification Example 1 of an example embodiment of the present invention.

FIG. 10 is a cross-sectional view illustrating a configuration of an end plate and a side plate according to Modification Example 2 of an example embodiment of the present invention.

FIG. 11 is a cross-sectional view illustrating a configuration of an end plate and a side plate according to Modification Example 3 of an example embodiment of the present invention.

FIG. 12 is a cross-sectional view illustrating a configuration of an end plate and a side plate according to Modification Example 4 of an example embodiment of the present invention.

FIG. 13 is a cross-sectional view illustrating a configuration of an end plate and a side plate according to Modification Example 5 of an example embodiment of the present invention.

### DETAILED DESCRIPTION OF THE EXAMPLE EMBODIMENTS

(1) An energy storage apparatus according to an example embodiment of the present invention includes an energy storage device, an end plate arranged in a first direction of the energy storage device, and a side plate extending in the first direction and joined to the end plate, wherein in at least one of the end plate or the side plate, a protruding portion is provided in at least one corner portion at which the first direction and a second direction which is orthogonal to the first direction intersect each other, and the protruding portion is configured such that a space, which opens on a side of the energy storage device, is defined by a deformation portion of at least one of the end plate or the side plate projected toward an outer side.

In an energy storage apparatus according to an example embodiment of the present invention, at least one of the end plate or the side plate includes the protruding portion which is deformed into a shape projected toward the outer side. Therefore, when the energy storage device has swollen in the first direction during charge and discharge, a force acting on the end plate or the side plate can be absorbed by the protruding portion. That is, the force acting on the end plate or the side plate can be absorbed by the deformation of the protruding portion.

(2) In the energy storage apparatus described in (1) above, the protruding portion may be located on the end plate.

According to the energy storage apparatus described in (2) above, since the protruding portion is located on the end plate arranged in the first direction of the energy storage device, the protruding portion is further easily deformed when the energy storage device has swollen in the first direction. That is, a force which acts on the end plate can be absorbed.

(3) In the energy storage apparatus described in (2) above, a thickness of the end plate in the first direction may be greater than a thickness of the side plate in the second direction.

According to the energy storage apparatus described in (3) above, the thickness of the end plate in the first direction is greater than the thickness of the side plate in the second direction. Therefore, when the energy storage device has swollen in the first direction, it is possible to restrain the protruding portion from being deformed excessively. Further, since the thickness of the side plate in the second direction is smaller than the thickness of the end plate in the first direction, it is possible to reduce or prevent an increase in the mass of the energy storage apparatus.

(4) In the energy storage apparatus described in (1) above, the protruding portion may be located on the side plate.

According to the energy storage apparatus described in (4) above, since the protruding portion is located on the side plate extending in the first direction, the protruding portion is further easily deformed when the energy storage device has swollen in the first direction. That is, a force which acts on the side plate can be absorbed.

(5) In the energy storage apparatus described in any one of (1) to (4), a cross section of the protruding portion taken parallel to the first direction and the second direction may have an arc shape.

According to the energy storage apparatus described in (5) above, since the cross section of the protruding portion preferably has an arc shape, it is possible to reduce or prevent local concentration of the force which acts on the protruding portion.

(6) In the energy storage apparatus described in any one of (1) to (5) above, the energy storage apparatus may include an exterior body to accommodate therein the energy storage device, the end plate, and the side plate, and a gap between a surface of the exterior body, which is opposed to the end plate, and the end plate.

According to the energy storage apparatus described in (6) above, a gap is located between the exterior body and the end plate. By this feature, when the exterior body is deformed by an external impact, it is possible to prevent a load acting on the deformed exterior body from directly acting on the end plate. As a result, damage to the energy storage device can be reduced or prevented. Also, when the energy storage device has swollen in the first direction, this gap can be used as a space to receive the swelling. As a result, damage to the exterior body can be reduced or prevented. In the meanwhile, the exterior body can restrict the swelling of the energy storage device such that the energy storage device does not swell too much.

In the following, example embodiments of energy storage apparatuses according to the present invention will be described with reference to the drawings. A numerical value, a shape, a material, an element, a position of arrangement and a configuration of connection of the elements, and the like, which are indicated in the following example embodiment(s) and modification example(s) thereof, are merely examples, and are not intended to limit the present invention. Each of the drawings is a schematic view, and dimensions and the like are not necessarily strictly illustrated. In the drawings, identical or similar elements are assigned a same reference numeral.

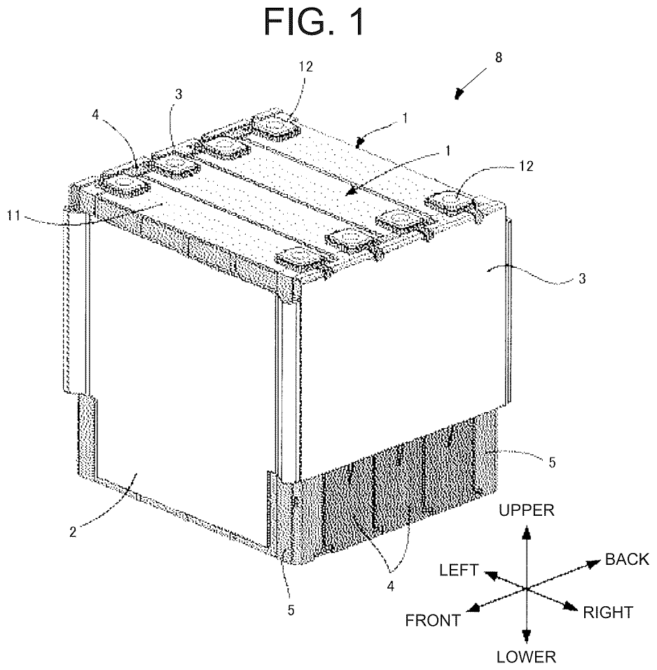

In the following description and drawings, for convenience of explanation, the example embodiments will be described in accordance with the directions indicated in FIGS. 1 to 4. However, these directions are set for convenience of explanation, and do not limit the present invention.

Expressions indicating relative directions or postures, such as parallel and orthogonal, include cases where the directions or postures are not parallel or orthogonal in a strict sense. Two directions being orthogonal to each other means not only that the two directions are completely orthogonal to each other, but also that the two directions are substantially orthogonal to each other, so that the two directions crossing each other at an angle deviated from 90 degrees by several degrees is also included in the scope. In the following description, when the expression “insulation/insulating” is used, “insulation/insulating” is intended as “electrical insulation”. A material having insulation properties may preferably be a material having a volume resistivity of 1×10⁶ Ωm or more, more preferably, 1×10⁷ Ωm or more, yet more preferably, 1×10¹⁰ Ωm or more, for example.

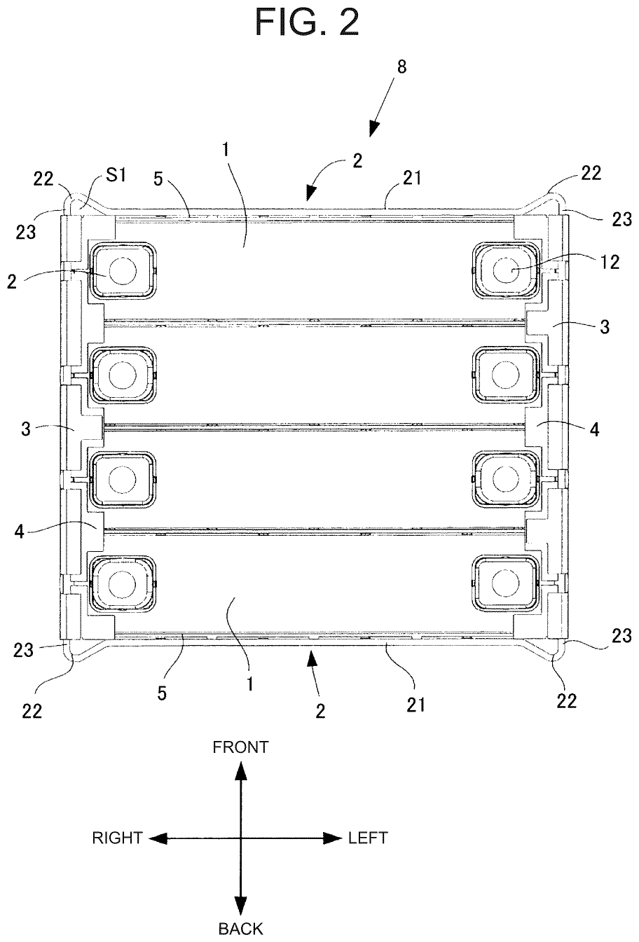

FIG. 1 is a perspective view illustrating a configuration of an energy storage apparatus 8 (in a state in which an exterior body 7 is removed) according to the present example embodiment. FIG. 2 is a plan view illustrating a configuration of the energy storage apparatus 8 (in a state in which the exterior body 7 is removed) according to the present example embodiment. As illustrated in FIGS. 1 and 2, the energy storage apparatus includes a plurality of energy storage devices 1 aligned in a front-back direction (a first direction), end plates 2 arranged at both ends of the plurality of energy storage devices 1 in the front-back direction, and side plates 3 sandwiching the plurality of energy storage devices 1 from both sides in a left-right direction (a second direction) which is orthogonal to the front-back direction. Further, a first spacer 4 or a second spacer 5 is located on a front surface or a back surface of the energy storage device 1. Each element will be described below.

The energy storage device 1 includes a primary battery, a secondary battery, a capacitor, or the like. In the present example embodiment, the energy storage device 1 including a chargeable and dischargeable non-aqueous electrolyte secondary battery is described as an example. More specifically, the energy storage device 1 is a lithium-ion secondary battery using electron transfer which takes place by the transfer of lithium ions. The energy storage device 1 has a flat rectangular parallelepiped shape (square shape, angular configuration) whose length is long in an upper-lower direction and in the left-right direction, and short in the front-back direction. In the present example embodiment, a plurality of (four) energy storage devices 1 are aligned in the front-back direction and are arrayed. However, the number of energy storage devices 1 to be arrayed is not particularly limited. The number of energy storage devices 1 may be one. A size and a shape of the energy storage device 1 are also not particularly limited, and the energy storage device 1 may not be long in the left-right direction and may not be flat in the front-back direction. The energy storage device 1 may not have a rectangular parallelepiped shape, but may have a long columnar shape, an elliptical columnar shape, a columnar shape, or a polygonal prism shape other than the rectangular parallelepiped shape, and the like. The energy storage device 1 is not limited to the non-aqueous electrolyte secondary battery, and may be a secondary battery other than the non-aqueous electrolyte secondary battery. The energy storage device 1 may be a battery using a solid electrolyte. The energy storage device 1 may be a pouch-type energy storage device.

The energy storage device 1 includes an electrode body (not illustrated), a case 11 in which the electrode body is accommodated together with an electrolytic solution (not illustrated), and a pair of terminals 12, at least a portion of which is exposed to an outer side of the case 11. The terminals 12 are provided on a surface of the case 11 in the upper-lower direction (a third direction) which is orthogonal to the front-back direction and the left-right direction.

The case 11 includes a case main body including an opening on an upper side in the upper-lower direction, and a plate-shaped lid body which closes the opening of the case main body. The terminals 12 are respectively located in the vicinity of both ends of the lid body in the left-right direction. The case 11 has a flat rectangular parallelepiped shape (square shape, angular configuration) whose length is long in the upper-lower direction and in the left-right direction, and short in the front-back direction. The cases 11 are aligned in the front-back direction such that surfaces thereof in the front-back direction are opposed to each other.

The first spacer 4 is a plate-shaped structure between two adjacently arranged energy storage devices 1, and includes a material having insulation properties. The first spacer 4 has the function of insulating between the two adjacently arranged energy storage devices 1, and also protecting the energy storage devices 1 from an external impact, and the like. The second spacer 5 is a plate-shaped structure which is arranged on one (front) side of the energy storage device 1 arranged at one end portion (front end) of the plurality of energy storage devices 1 in the front-back direction, and on an other (back) side of the energy storage device 1 arranged at an other end portion (back end) of the same in the front-back direction. The second spacer 5 includes a material having insulation properties. The second spacer 5 has the function of insulating between the energy storage device 1 and the end plate 2, which will be described later, and also protecting the energy storage device 1 from an external impact, and the like.

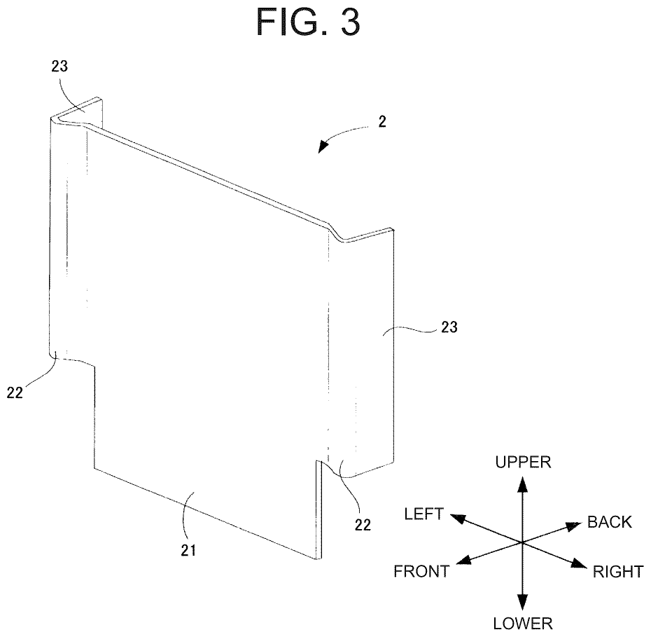

FIG. 3 is a perspective view illustrating a configuration of the end plate 2 according to the present example embodiment. As illustrated in FIG. 2, the end plate 2 is arranged on the one (front) side of the energy storage device 1 which is arranged at the one end portion (front end) in the front-back direction, and on the other (back) side of the energy storage device 1 which is arranged at the other end portion (back end) in the front-back direction. In the present example embodiment, a pair of end plates 2 are used. However, since the end plates 2 have shapes symmetrical to each other in the front-back direction, the end plate 2 which is in contact with the energy storage device 1 located at the one end portion (front end) in the front-back direction will be described with reference to FIG. 3. Note that the second spacer 5 described above is located between the energy storage device 1 and the end plate 2 to insulate between the two.

As illustrated in FIG. 3, the end plate 2 includes a rectangular main body portion 21, protruding portions 22 joined to both ends of the main body portion 21 in the left-right direction; and side surface portions 23 respectively joined to the protruding portions 22, and the aforementioned portions are integrally formed. The end plate 2 is formed preferably by bending a metal plate material.

The main body portion 21 is a rectangular or substantially rectangular structure which is in contact with the second spacer 5. A length of the main body portion 21 in the upper-lower direction is shorter than that of the energy storage device 1 in the upper-lower direction, and a length of the main body portion 21 in the left-right direction is also shorter than that of the energy storage device 1 in the left-right direction.

The protruding portions 22 are joined to upper portions on the both ends of the main body portion 21, respectively. An upper end of the main body portion 21 corresponds with an upper end of the protruding portions 22. In other words, the upper end of the main body portion 21 and the upper end of the protruding portions 22 are positioned on the same straight line. Further, as illustrated in FIG. 2, the protruding portion 22 is curved in an arc shape so as to be projected toward the front in the front-back direction as seen in a plan view (upper-lower direction). Thus, a space S1 is provided between a surface (a back surface) of the protruding portion 22, which is opposed to the energy storage device 1, and the second spacer 5.

The side surface portion 23 is a rectangular or substantially rectangular structure extending toward the back in the front-back direction from an end portion of the protruding portion 22, which is on a side opposite to an end portion of the protruding portion 22 that is closer to the main body portion 21. A length of the side surface portion 23 in the upper-lower direction is the same as that of the protruding portion 22 in the upper-lower direction. A length of the side surface portion 23 in the front-back direction is shorter than that of the energy storage device 1 in the front-back direction. The side surface portion 23 is covered with the side plate 3, and is bonded to the side plate 3 by welding, adhesive bonding, bolting, or the like.

When the energy storage device 1 swells in the front-back direction due to charge and discharge, a central portion of the surface of the energy storage device 1 oriented in the front-back direction becomes the most swollen portion. For this reason, in order to reduce or prevent the swelling of the energy storage device 1, the main body portion 21 should preferably be positioned to be in contact with the central portion of the surface of the energy storage device 1 oriented in the front-back direction. Here, the central portion of the surface of the energy storage device 1 oriented in the front-back direction refers to a region corresponding to a central portion when the surface of the energy storage device 1 oriented in the front-back direction is divided into three equal portions in the upper-lower direction, and also corresponding to a central portion when the surface is divided into three equal portions in the left-right direction.

The case 11 of the energy storage device 1 includes a bonding portion 13 for bonding the case main body and the lid body to each other. The bonding portion 13 is a portion which is weak in terms of the strength in the case 11. Therefore, when the main body portion 21 comes into contact with the bonding portion 13 in the front-back direction, the bonding portion 13 receives a load from the main body portion 21 and may be damaged. Therefore, the main body portion 21 should preferably be located at a position where the main body portion 21 does not come into contact with the bonding portion 13 of the case 11.

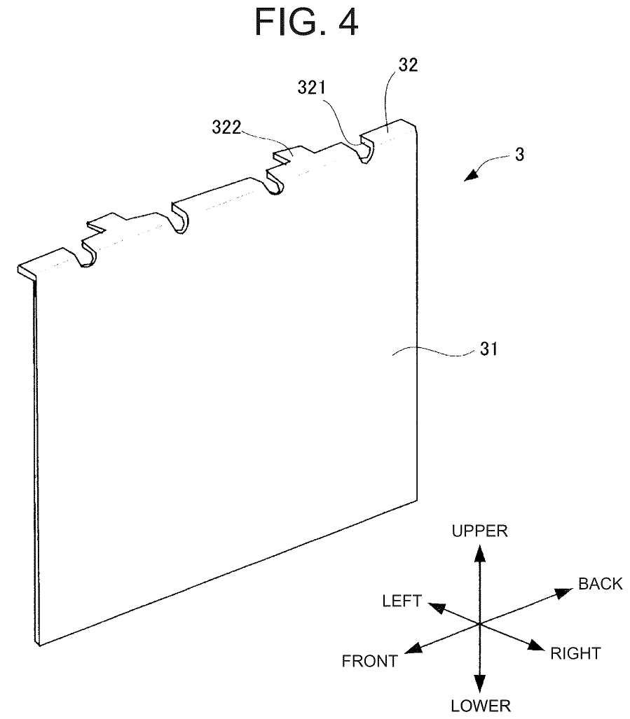

FIG. 4 is a perspective view illustrating a configuration of the side plate 3 according to the present example embodiment. In the present example embodiment, a pair of side plates 3 are used. However, since the side plates 3 have shapes which are bilaterally symmetrical to each other, the side plate 3 located on the right side of the energy storage device 1 will be described.

As illustrated in FIG. 4, the side plate 3 is formed preferably by bending a single sheet of metal plate, and includes a rectangular or substantially rectangular first portion 31, and a second portion 32 extending leftward from an upper end of the first portion 31. A length of the first portion 31 in the upper-lower direction is greater than that of the side surface portion 23 of the end plate 2 in the upper-lower direction. When the end plate 2 and the side plate 3 are bonded to each other, the first portion 31 extends upward beyond an upper end of the side surface portion 23. The second portion 32 is a portion which is bent from the upper end of the first portion 31, and is configured to engage with an upper surface of the first spacer 4 or the second spacer 5. In the second portion 32, a cutout 321 or a protrusion 322 is formed according to the shape of the first spacer 4 or the second spacer 5 which is in contact with the second portion 32.

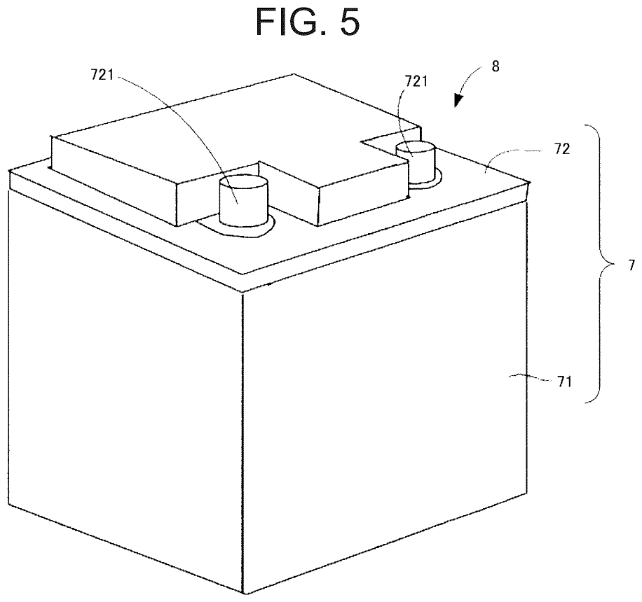

FIG. 5 is a perspective view illustrating a configuration of the energy storage apparatus 8 (in a state in which the exterior body 7 is mounted) according to the present example embodiment.

A method of assembling the energy storage apparatus 8 will be described. First, a plurality of energy storage devices 1 are aligned in the front-back direction. Here, the first spacer 4 is located between two adjacently arranged energy storage devices 1. Next, the second spacer 5 and the end plate 2 are arranged on the one (front) side of the energy storage device 1 which is arranged at the one end portion (front end) in the front-back direction, and on the other (back) side of the energy storage device 1 which is arranged at the other end portion (back end) in the front-back direction. Subsequently, a pair of side plates 3 are positioned so as to sandwich the plurality of energy storage devices 1, the first spacers 4, the second spacers 5, and a pair of end plates 2 in the directions of the left-right direction, and the pair of side plates 3 are fixed to the pair of end plates 2. That is, the second portion 32 of the side plate 3 is engaged with the upper surface of the first spacer 4 or the second spacer 5, and also, a front end and a back end of the side plate 3 are bonded to the respective side surface portions 23 of the pair of end plates 2 by welding, adhesive bonding, bolting, or the like.

After that, the plurality of energy storage devices 1, the first spacers 4, the second spacers 5, the pair of end plates 2, and the pair of side plates 3 are accommodated in the exterior body 7. The exterior body 7 includes a rectangular or substantially rectangular parallelepiped-shaped main body 71 including an opening on an upper side thereof, and a lid body 72 which closes the opening of the main body 71. An external terminal 721 is provided on the lid body 72. The plurality of energy storage devices 1, the first spacers 4, the second spacers 5, the pair of end plates 2, and the pair of side plates 3 are accommodated in the main body 71, and then the opening of the main body 71 is closed by the lid body 72. Also, the terminals 12 of the plurality of energy storage devices 1 are connected to each other by a bus bar (not illustrated). Furthermore, the terminals 12 are electrically connected to the external terminals 721 of the lid body 72 by the bus bar.

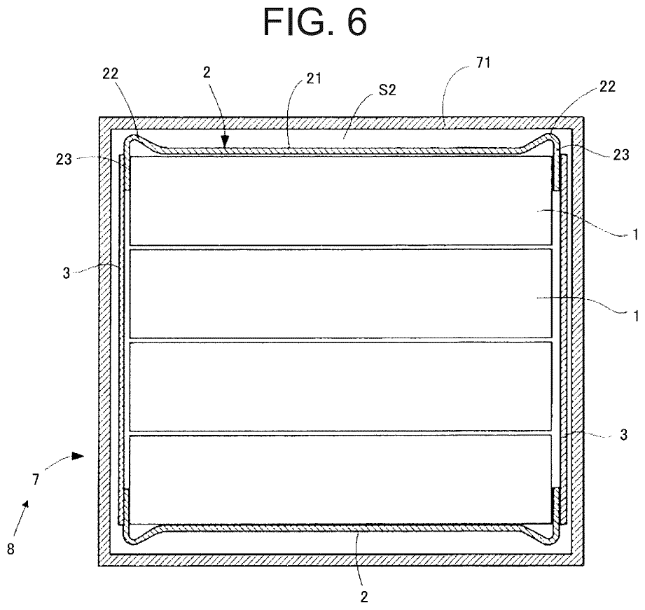

FIG. 6 is a cross-sectional view illustrating a configuration of the energy storage apparatus 8 (in a state in which the exterior body 7 is mounted) according to the present example embodiment. As illustrated in FIG. 6, when the energy storage apparatus 8 includes the exterior body 7, a space S2 is provided between the main body portion 21 of the end plate 2 and a sidewall of the main body 71. In FIG. 6, for convenience of explanation, the first spacer 4 and the second spacer 5 are omitted.

A thickness of the end plate 2 in the front-back direction should preferably be greater than that of the side plate 3 in the left-right direction. When the energy storage device 1 has swollen in the front-back direction, it is possible to restrain the protruding portion 22 from being deformed excessively. Further, since the thickness of the side plate 3 in the left-right direction is smaller than the thickness of the end plate 2 in the front-back direction, it is possible to reduce or prevent an increase in the mass of the energy storage apparatus 8. If the protruding portion 22 is excessively deformed to such an extent that the protruding portion 22 is plastically deformed, a binding force required to bind the energy storage device 1 is not produced, and the performance of the energy storage device 1 may deteriorate. Therefore, as the protruding portion 22 is provided on the end plate 2 whose thickness is greater than that of the side plate 3, a maximum stress which acts on the end plate 2 can be reduced without adversely affecting the performance of the energy storage device 1.

It is sufficient if the thickness of the end plate 2 in the front-back direction is greater than the thickness of the side plate 3 in the left-right direction. It is sufficient if the thickness of one end plate 2 of the pair of end plates 2 is greater than the thickness of one side plate 3 of the pair of side plates 3.

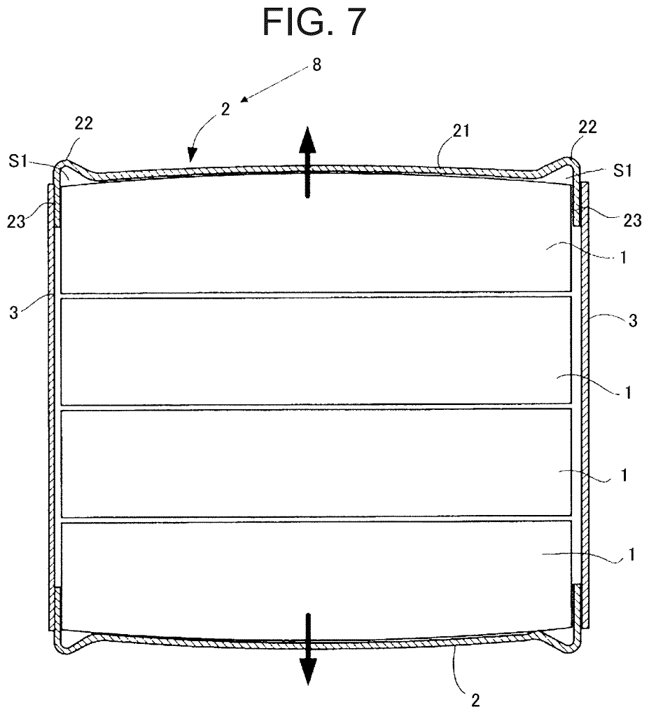

FIG. 7 is a cross-sectional view indicating a behavior of the end plate 2 when the energy storage apparatus 8 according to the present example embodiment has swollen.

The energy storage apparatus 8 configured as described above brings about the following advantages.

When the energy storage device 1 has swollen in the front-back direction due to charge and discharge as illustrated in FIG. 7, a force acting on the end plate 2 can be absorbed by the protruding portion 22. At this time, while a force acts on the end plate 2 such that the end plate 2 expands outward, by virtue of the protruding portion 22 provided, a portion of the force can be made to act on the protruding portion 22. That is, the protruding portion 22 can be deformed in such a way that the space S1 of the protruding portion 22 is widened in conjunction with the deformation of the end plate 2. Therefore, it is possible to reduce or prevent local concentration of the force which acts on the end plate 2, and the acting force can be dispersed. Therefore, the maximum stress which acts on the end plate 2 can be reduced, and it becomes possible to implement a design in which rigidity required for the end plate 2 is lowered. Other than the above, one possible action is to increase the rigidity of the end plate 2. Specifically, the Young's modulus of the material of the end plate 2 may be increased, or the thickness of the end plate 2 may be increased. In this case, disadvantages such as the cost of the end plate 2 being increased and the mass of the energy storage apparatus 8 being increased are caused. The energy storage apparatus 8 of the present example embodiment can reduce the maximum stress which acts on the end plate 2 while reducing or preventing a concern about the above-described disadvantages. Note that in FIG. 7, the swelling of the energy storage device 1 is exaggeratedly depicted for convenience of explanation. Further, the first spacer 4 and the second spacer 5 are omitted.

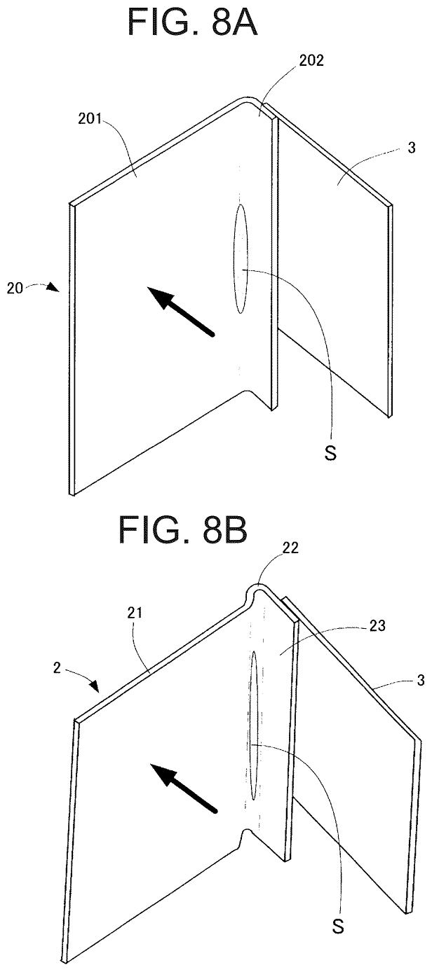

FIGS. 8A and 8B show an outline of a result of a simulation conducted by the inventor of example embodiments of the present invention with respect to the above point. FIGS. 8A and 8B are schematic views showing simulation results of stress distributions when a force is applied to an end plate 20 of a comparative example and the end plate 2 according to the present example embodiment. Illustration FIG. 8A shows a model (comparative example) in which the end plate 20, which does not have a protruding portion and includes a main body portion 201 and a side surface portion 202, is used, and the side plate 3 is joined to the end plate 20. Illustration FIG. 8B shows a model in which the side plate 3 is joined to the end plate 2 according to the present example embodiment.

These models were used and a force in the direction of an arrow was applied to the end plates 2 and 20. Here, in the model of illustration FIG. 8A, a stress acting on a joined portion between the main body portion 201 and the side surface portion 202 in the end plate 20 became the greatest. Meanwhile, in the model of illustration FIG. 8B, a stress acting on the protruding portion 22 of the end plate 2 became the greatest. Further, in the model of illustration FIG. 8B, a region S in which the stress exhibits the maximum value was more elongated than that of the model of illustration FIG. 8A. That is, it has been discovered that the stress acting on the end plate 2 is more dispersed than the stress acting on the end plate 20. Furthermore, the maximum stress acting on the model of illustration FIG. 8B was approximately 20% less than the maximum stress acting on the model of illustration FIG. 8A.

The thickness of the end plate 2 in the front-back direction is greater than the thickness of the side plate 3 in the left-right direction. Therefore, when the energy storage device 1 has swollen in the front-back direction, it is possible to restrain the protruding portion 22 from being deformed excessively. Further, since the thickness of the side plate 3 in the left-right direction is smaller than the thickness of the end plate 2 in the front-back direction, it is possible to reduce or prevent an increase in the mass of the energy storage apparatus 8. If the protruding portion 22 is excessively deformed to such an extent that the protruding portion 22 is plastically deformed, a binding force required to bind the energy storage device 1 is not produced, and the performance of the energy storage device 1 may deteriorate. Therefore, as the protruding portion 22 is provided on the end plate 2 whose thickness is greater than that of the side plate 3, a maximum stress which acts on the end plate 2 can be reduced without adversely affecting the performance of the energy storage device 1.

Since a cross section of the protruding portion 22 has an arc shape, s possible to reduce or prevent local concentration of the force acting on the protruding portion 22.

As illustrated in FIG. 6, when the energy storage apparatus 8 includes the exterior body 7, the space S2 is located between the sidewall 71 of the exterior body 7 and the main body portion 21 of the end plate 2. By this feature, when the exterior body 7 is deformed by an external impact, it is possible to prevent a load acting on the deformed exterior body 7 from directly acting on the end plate 2. As a result, damage to the energy storage device 1 can be reduced or prevented. Further, as the space S2 is provided, when the energy storage device 1 has swollen in the front-back direction, the space S2 can be used as a space to receive the swelling. As a result, damage to the exterior body 7 can be reduced or prevented. In the meanwhile, the sidewall 71 of the exterior body 7 can restrict the swelling of the energy storage device 1 such that the energy storage device 1 does not swell too much.

Energy storage apparatuses 8 according to example embodiments of the present invention has been described above. However, the present invention is not limited to the above-described example embodiments, and various alterations can be made without departing from the spirit of the present invention. Note that the following modification examples can be combined with the above-described example embodiments, and the modification examples can be combined with each other as appropriate.

In the above-described example embodiments, while the protruding portion 22 is provided on the end plate 2, the position or orientation of the protruding portion is not particularly limited, and various modes are possible. That is, the protruding portion may be located in the vicinity of a corner portion where the end plate 2 and the side plate 3 intersect each other.

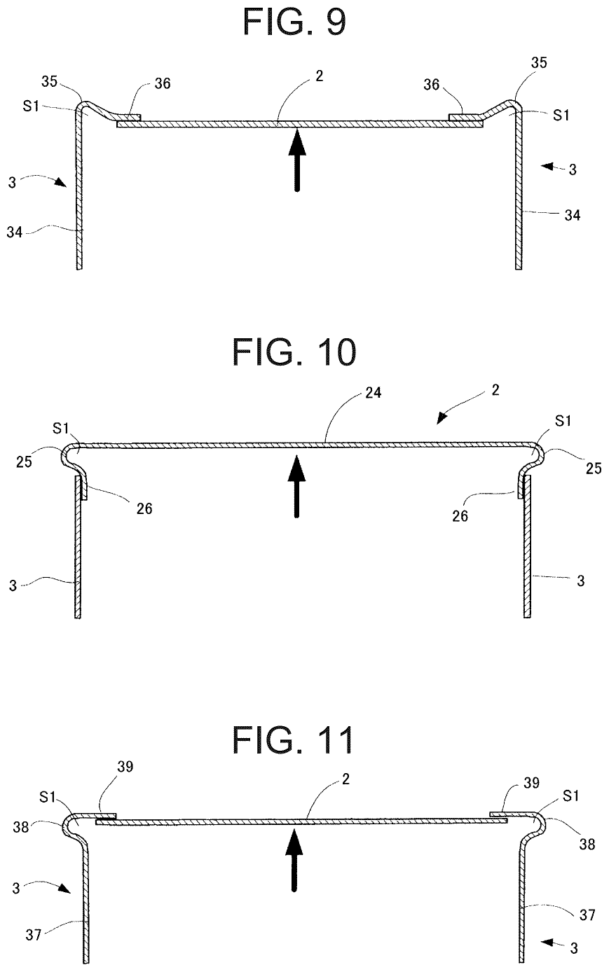

As illustrated in FIG. 9, the end plate 2 may include only a flat main body portion, and the side plate 3 may be provided with a protruding portion 35. More specifically, the side plate 3 includes a plate-shaped main body portion 3, the protruding portion 35 which is curved so as to be projected toward the front in the front-back direction from a front end of the main body portion 34, and a front surface portion 36 which extends in the left-right direction from an end portion of the protruding portion 35 on a side opposite to the main body portion 34. A back surface or a front surface of the front surface portion 36 is bonded to the end plate 2 by welding, adhesive bonding, bolting, or the like. Even in a mode as described above, a force which acts on the side plate 3 can be absorbed by the protruding portion 35 of the side plate 3. That is, since the protruding portion 35 is deformed such that the space S1 of the protruding portion 35 is widened, the force acting on the side plate 3 can be absorbed.

As illustrated in FIG. 10, a protruding portion provided on the end plate 2 is caused to extend not toward the front in the front-back direction, but toward the right-left direction in which a main body portion 24 extends, and is curved so as to be projected laterally. Even in a mode as described above, a force which acts on the end plate 2 can be absorbed by a protruding portion 25.

As illustrated in FIG. 11, while a protruding portion is provided on the side plate 3, this protruding portion, i.e., a protruding portion 38, is provided in such a way that it is curved to be projected in the left-right direction. Even in a mode as described above, a force which acts on the side plate 3 can be absorbed by the protruding portion 38 of the side plate 3.

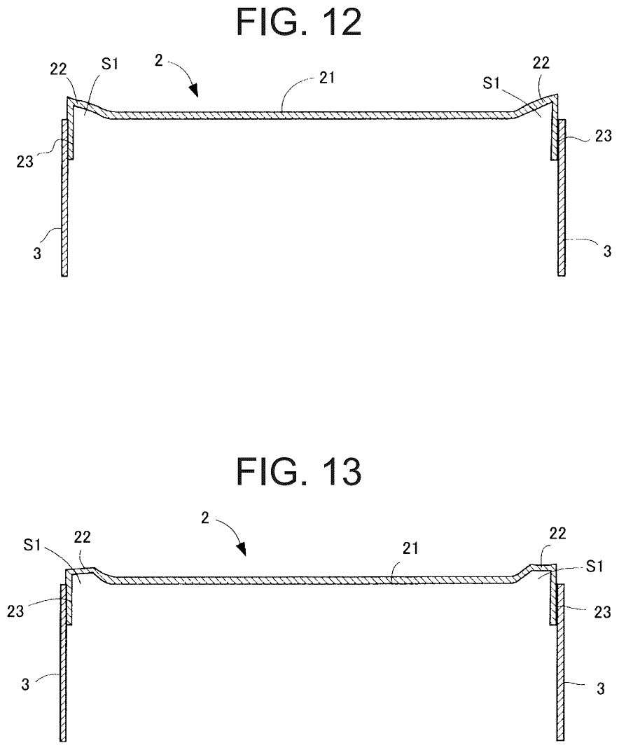

In the above-described example embodiments, although a cross section of the protruding portion 22 is curved in an arc shape, the protruding portion 22 is not limited to this shape. As illustrated in FIG. 12, a cross section of the protruding portion 22 may have a shape which is projected at an acute angle. As illustrated in FIG. 13, a cross section of the protruding portion 22 may have a shape which is projected like a rectangle. That is, the cross-sectional shape may include a flat surface substantially parallel to the main body portion 21. Even if the protruding portion 22 has an acute-angled projected shape or a rectangular projected shape, the protruding portion 22 is deformed such that the space S1 is widened. Therefore, it is possible to absorb the force which acts on the end plate 2. However, it is preferable if the cross section of the protruding portion 22 has a curved shape since the curved shape can reduce or prevent local application of the force.

As described above, the direction in which the protruding portion 22 protrudes is not particularly limited, and can be determined as appropriate in relation to the exterior body 7. However, preferably, the protruding direction should be the direction in which the energy storage devices 1 are aligned.

In the above-described example embodiments, the protruding portions 22 are provided at four corner portions defined by the pair of end plates 2 and the pair of side plates 3. However, the places where the protruding portions 22 are provided is not limited to the above. The protruding portion 22 may be provided only at two corner portions at either one end in the front-back direction, or may be provided only at two corner portions at either one end in the left-right direction. Alternatively, the protruding portion 22 may be provided at only one corner portion of the four corner portions.

The configuration of the energy storage device 1 is not particularly limited, and a configuration of a known energy storage device can be adopted. Further, the shapes of the first spacer 4, the second spacer 5, and the exterior body 7 may be changed as appropriate.

In the above-described example embodiments, the pair of end plates 2 and the pair of side plates 3 are used. However, the end plate 2 may be provided only at one end portion of the plurality of energy storage devices 1. Further, only one side plate 3 may be provided. Further, it is not essential that the end plate 2 and the side plate 3 be separate bodies. That is, the end plate 2 and the side plate 3 may be integrally formed without any bonding portion.

The above-described example embodiments has been configured such that the thickness of the end plate 2 in the front-back direction is greater than the thickness of the side plate 3 in the left-right direction. However, this configuration is not essential. A configuration in which the thickness of the end plate 2 is the same as the thickness of the side plate 3 may be used, or a configuration in which the thickness of the end plate 2 is smaller than the thickness of the side plate 3 may be used.

In the above-described example embodiments, the energy storage apparatus 8 includes the exterior body 7. However, it is not essential that the energy storage apparatus 8 include the exterior body 7. That is, the plurality of energy storage devices 1, the first spacers 4, the second spacers 5, the pair of end plates 2, and the pair of side plates 3 may be directly provided within a housing of a vehicle.

Example embodiments of the present invention can be applied to energy storage apparatuses including energy storage devices such as lithium-ion secondary batteries.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
an energy storage device;
an end plate arranged in a first direction of the energy storage device; and
a side plate extending in the first direction and joined to the end plate; wherein
in at least one of the end plate or the side plate, a protruding portion is provided in at least one corner portion at which the first direction and a second direction which is orthogonal to the first direction intersect each other; and
the protruding portion is configured such that a space, which opens on a side of the energy storage device, is defined by a deformation portion of at least one of the end plate or the side plate projected toward an outer side.

2. The energy storage apparatus according to claim 1, wherein the protruding portion is located on the end plate.

3. The energy storage apparatus according to claim 2, wherein a thickness of the end plate in the first direction is greater than a thickness of the side plate in the second direction.

4. The energy storage apparatus according to claim 1, wherein the protruding portion is located on the side plate.

5. The energy storage apparatus according to claim 1, wherein a cross section of the protruding portion taken parallel to the first direction and the second direction has an arc shape.

6. The energy storage apparatus according to claim 1, further comprising:
an exterior body to accommodate therein the energy storage device, the end plate, and the side plate; and
a gap between a surface of the exterior body, which is opposed to the end plate, and the end plate.
